(19) United States
(12) Patent Application Publication
(10) Pub. No.: US 2025/0392177 A1
(43) Pub. Date: Dec. 25, 2025

(54) ROTOR AND ELECTRIC MACHINE

(71) Applicant: FEAAM GmbH, Neubiberg (DE)

(72) Inventor: Gurakuq Dajaku, Neubiberg (DE)

(73) Assignee: FEAAM GmbH, Neubiberg (DE)

(21) Appl. No.: 19/240,900

(22) Filed: Jun. 17, 2025

(30) Foreign Application Priority Data
Jun. 19, 2024 (DE) 102024117284.3

(51) Int. Cl. H02K 1/276; H02K 21/14

(52) U.S. Cl. CPC H02K 1/276; H02K 21/14

(57) ABSTRACT

A rotor for an electric machine comprises a rotor core and a rotor axle. Furthermore, at least one permanent magnet is provided, which is extended in axial main direction and has an axial length that is larger than the axial length of the rotor core. The at least one permanent magnet is arranged in a magnet module in each case and the magnet module has a larger axial length than the rotor core.

### CROSS-REFERENCE TO RELATED APPLICATIONS

The present application claims priority under 35 U.S.C. § 119 to German Patent Application No. 101024117284.3, filed on Jun. 19, 2024, the disclosure of which is hereby incorporated by reference in its entirety.

### FIELD

The present invention relates to a rotor for an electric machine as well as to an electric machine comprising the rotor and a stator.

### BACKGROUND

Since the beginning of the industrial revolution, electric machines have been of great importance and their role continues to increase in the present. They play a crucial role in everyday life, for example in household appliances, robotics, the automotive industry, aerospace, wind turbines and so on. Compared to combustion engines, electric machines are more efficient, cheaper and simpler in design.

The two main components of an electric machine are a stator and a rotor mounted so as to be movable relative to the stator.

The stator and the rotor usually comprise magnetic material. There is an air gap between the stator and the rotor. The stator usually has grooves that face the air gap and are distributed along the circumference. Coils of a winding are inserted in these grooves. A distinction is made between two types, namely tooth-concentrated windings and distributed windings.

Distributed windings comprise coils that are each wound around at least two teeth and overlap each other in the winding head.

The parts of the winding that protrude beyond the stator grooves in the axial direction are referred to as the winding head. With concentrated windings, the coils do not overlap in the area of the winding head and therefore the structure is more compact.

In electric machines, torque is only generated in the area of the stator core, i.e. in the area of the axial length of the stator core. This axial length is therefore often referred to as the active length of the stator. As the winding heads are located outside this active length, this part of the winding does not contribute to torque generation.

On the contrary, ohmic losses occur in the area of the winding heads, which have a negative effect on the efficiency of the machine. The shorter the axial length of the machine, for example due to spatial restrictions in the application, the more significant the aforementioned disadvantages due to the winding heads become.

It is therefore an object to specify a rotor and an electric machine whose properties are improved.

This object is achieved with the subject-matter of the independent claims. Further developments and advantageous designs are given in the subclaims.

### SUMMARY

In one embodiment, a rotor for an electric machine is provided, which comprises a rotor core and a rotor axle. Furthermore, at least one permanent magnet is provided, which—on at least one side—is extended further in the axial direction than the rotor core.

Normally, torque is only generated in the area of the air gap between the rotor and stator, i.e. in the area of the active length of the stator. However, since according to the proposed principle the at least one permanent magnet is extended in the axial direction beyond the rotor core, the otherwise unused space is utilized to make an additional contribution to torque generation and thus increase the available torque.

The area located in the region of the winding heads, which is arranged axially outside the stator core of the rotor, no longer remains unused.

The at least one permanent magnet may comprise one or more of the following types: tangential magnets, V-shaped magnets, spoke magnets.

Several permanent magnets in the rotor can be alternately magnetized along the circumference as north pole or south pole.

In one embodiment, the at least one permanent magnet is magnetized in an axis perpendicular to the rotor axle.

In one embodiment, the at least one permanent magnet is installed in the rotor core.

In one embodiment, the at least one permanent magnet is arranged in a magnet module in each case. The magnet module has a larger axial length than the rotor core.

The magnet module amplifies the magnetic flux by directing it from the part of the magnet outside the active length into the area of the active length. This further increases the torque.

In one embodiment, the axial length of the magnet module is larger than the axial length of the permanent magnet.

In one embodiment, the magnet module covers the permanent magnet axially in a plane perpendicular to the direction of magnetization.

In one embodiment, the rotor core comprises magnetic material.

In one embodiment, the magnet module comprises magnetic material in each case.

The rotor core may comprise at least one of the following types: a laminated iron core, a soft magnetic composite material, solid steel.

The axial length of the magnet module may be larger than or equal to the axial length of the magnet.

In one embodiment, an electric machine is disclosed having a rotor as described above and a stator.

In the proposed machine, the space required by the winding heads of the stator in the axial direction can also be utilized in the area of the stator, namely to increase the torque of the machine.

In one embodiment, the stator has grooves in which coils of an electric winding are inserted.

For example, the axial length of the at least one permanent magnet can be less than or equal to the axial length of the stator including the winding heads.

In one embodiment, the axial length of the at least one rotor module is less than or equal to the axial length of the stator including the winding heads.

The axial length of the stator and of the rotor at the air gap may be the same.

The invention is explained in more detail below with reference to several exemplary embodiments with the aid of drawings.

### BRIEF DESCRIPTION OF THE DRAWINGS

In the Figures:

FIG. 1 shows an exemplary embodiment of an electric machine according to the proposed principle,

FIGS. 2 to 6 each show exemplary embodiments of a magnet module according to the proposed principle,

FIGS. 7 to 11 each show exemplary embodiments with tangential permanent magnets according to the proposed principle,

FIG. 12 shows an exemplary embodiment of a rotor according to the proposed principle,

FIG. 13 shows an exemplary embodiment of an electric machine according to the proposed principle,

FIGS. 14 to 19 each show exemplary embodiments with V-shaped magnets according to the proposed principle,

FIGS. 20 to 23 each show exemplary embodiments with spoke magnets according to the proposed principle, and

FIGS. 24 to 27 each show exemplary embodiments of a magnet module according to the proposed principle.

### DETAILED DESCRIPTION

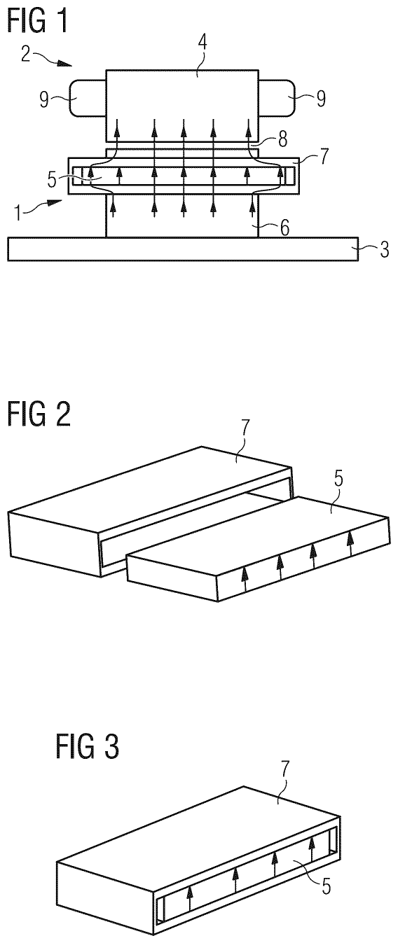

FIG. 1 shows, on the basis of a cross-sectional view of a section, an exemplary embodiment of an electric machine according to the proposed principle.

The electric machine comprises a rotor 1 and a stator 2. The rotor 1 is mounted so as to rotate about an axle 3. Below the axle, which is also the axis of symmetry, the symmetric parts of rotor 1 and stator 2 are present, but not shown.

The stator 2 comprises a winding (not visible) that is inserted into grooves in the stator. However, the winding heads 9 are visible, which are arranged on the end face of the stator and project beyond the stator core 4 in the axial direction.

The rotor 1 comprises a permanent magnet 5, the main direction of which extends parallel to the axle 3. It can be seen that the permanent magnet 5 is longer in the axial direction than the rotor core 6 of the rotor.

The permanent magnet 5 is installed in a magnet module 7, which surrounds the permanent magnet 5 in the radial direction and in the axial direction.

The stator core 4 and the rotor core 6 have the same axial length and are spaced apart from each other by an air gap 8.

Normally, torque is only generated in the area of the air gap 8 between the rotor 1 and the stator 2, i.e. in the area of the stator core 4. However, since according to the proposed principle the at least one permanent magnet 5 is extended in axial direction beyond the rotor core 6, i.e. beyond the active length of the rotor, the otherwise unused space is utilized to make an additional contribution to torque generation and thus increase the available torque.

The area located in the region of the winding heads 9, which is arranged axially outside the stator core 4 of the rotor, no longer remains unused.

The magnet module 7 increases the magnetic flux by directing it from the part of the magnet 5 outside the active length into the area of the active length. This further increases the torque.

FIG. 2 shows an exemplary embodiment of a magnet module 7 before the permanent magnet 5 is inserted into it. It can be seen that the permanent magnet 5 has a cuboid and flat geometry and fits positively into the magnet module 5, which is also cuboid on the inside and outside. The arrows on the permanent magnet 5 indicate the direction of magnetization with north and south poles.

FIG. 3 shows the exemplary embodiment of FIG. 2 after the permanent magnet 5 has been inserted into the magnet module 7. In this example, the magnet module comprises SMC, i.e. soft magnetic composite materials, or solid iron or solid steel.

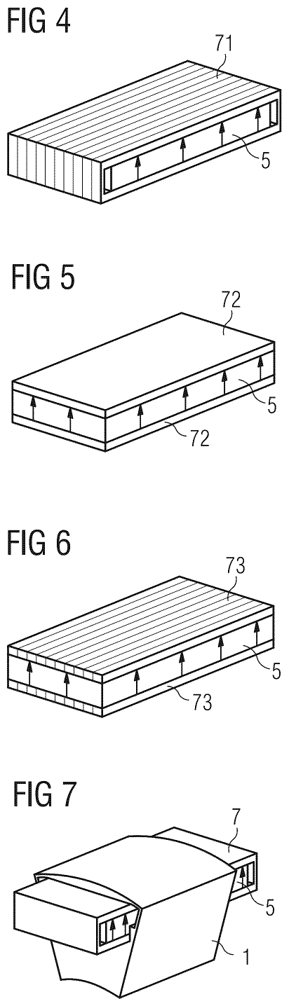

Alternatively, as shown in FIG. 4, the magnet module 71 comprises laminated iron or laminated steel. Here, the direction of lamination is along the circumferential direction of the machine.

In another alternative embodiment with regard to FIG. 3, instead of the cuboid magnet module, a sandwich structure is shown which comprises two flat parts of the magnet module 72 with the permanent magnet 5 in between.

A combination of the designs of FIGS. 3 and 5 is shown in FIG. 6, i.e. the sandwich structure of the magnet module 73, which here comprises laminated iron.

Various exemplary embodiments of the permanent magnets in the form of tangential magnets, V-magnets or spoke magnets will be explained below.

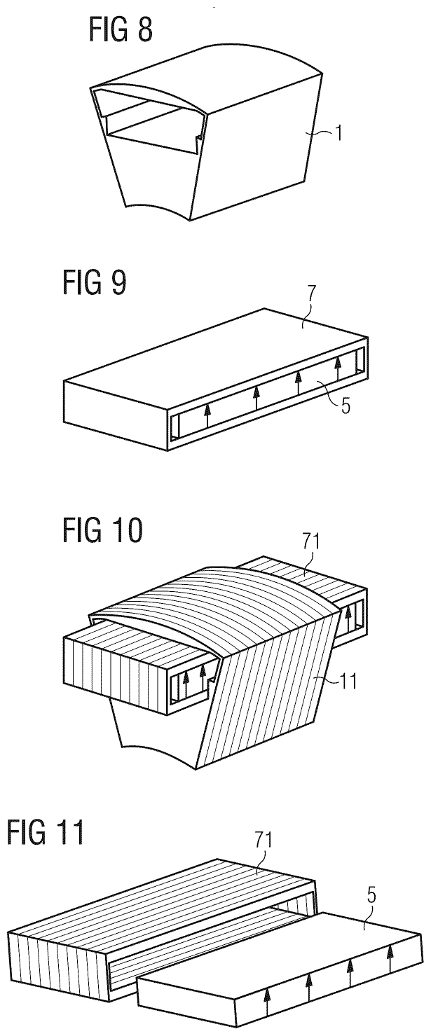

FIG. 7 shows an exemplary embodiment of the permanent magnet 5 as a tangential magnet in a sector of the rotor 1. Only one rotor pole is shown here. In this example, the permanent magnet 5 is enclosed by a magnet module 7, as explained with the aid of FIG. 3 and shown here in FIG. 9. For better understanding, FIG. 8 shows the sector of rotor 1 from FIG. 7, but without the permanent magnet and without the magnet module.

An alternative exemplary embodiment of the permanent magnet 5, designed as a tangential magnet, in a sector of the rotor is shown in FIG. 10. This is a variant of the design in FIG. 7, but in which both the rotor core 11 and the magnet module 71 are realized with laminated iron. FIG. 11 shows the magnet module 71 of FIG. 10 without the tangential permanent magnet 5 having been inserted, which is shown here next to the magnet module 71.

FIG. 12 shows a perspective view of the complete rotor 1 with the permanent magnets 5 designed as tangential magnets as described above with reference to FIGS. 7 to 9 on the basis of an exemplary embodiment. Each permanent magnet 5 is installed in a magnet module. A total of 10 permanent magnets 5 are distributed along the circumference. It can be seen that all permanent magnets with the associated magnet module each have the same geometry and each protrude beyond the rotor core in axial direction on both end faces of the rotor 1. The latter also applies to the respective magnet modules 7.

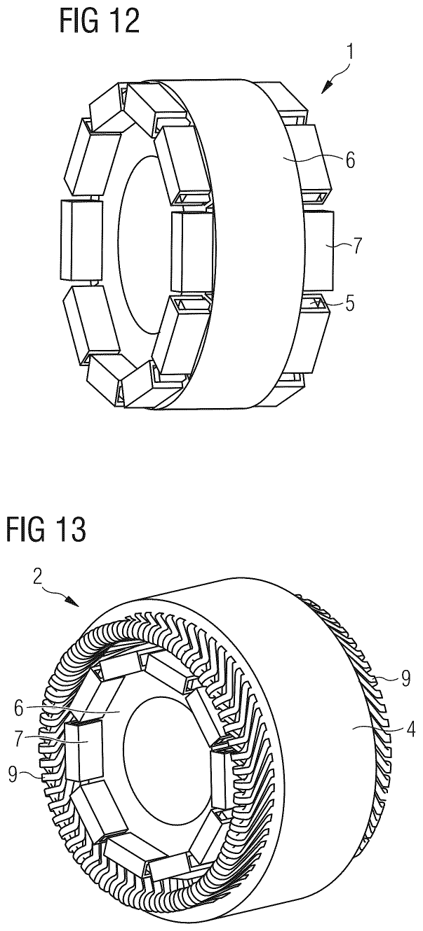

FIG. 13 shows an exemplary embodiment of an electric machine according to the proposed principle. In addition to the rotor 1, which corresponds to that of FIG. 12, a stator 2 is provided which has numerous parallel grooves distributed along the circumference, into each of which conductors of associated coils of an electric winding are inserted. The winding heads projecting beyond the stator core in the axial direction on both end faces of the stator are clearly visible.

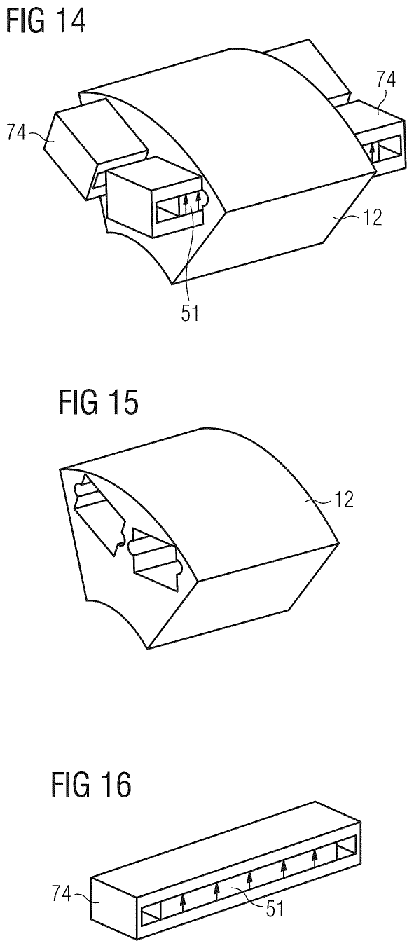

FIGS. 14 to 16 show an exemplary embodiment of a rotor 12 with V-shaped permanent magnets 51, each of which being inserted in a magnet module 74.

FIG. 14 shows a sector of the rotor 12. It can be seen that, as in the examples above, the permanent magnets each project significantly beyond the rotor core in the axial direction.

FIG. 15 shows the sector of the rotor 12 before the magnet modules 74 with the permanent magnets 51 are inserted.

FIG. 16 shows the magnet module 74 with the permanent magnet 51 for respective insertion into the two openings of the rotor 12 of FIG. 15.

Also in the exemplary embodiment according to FIGS. 14 to 16, the magnet modules with the permanent magnets, which protrude beyond the axial length of the stator core, result in the flux density in the air gap being increased and thus more torque being available.

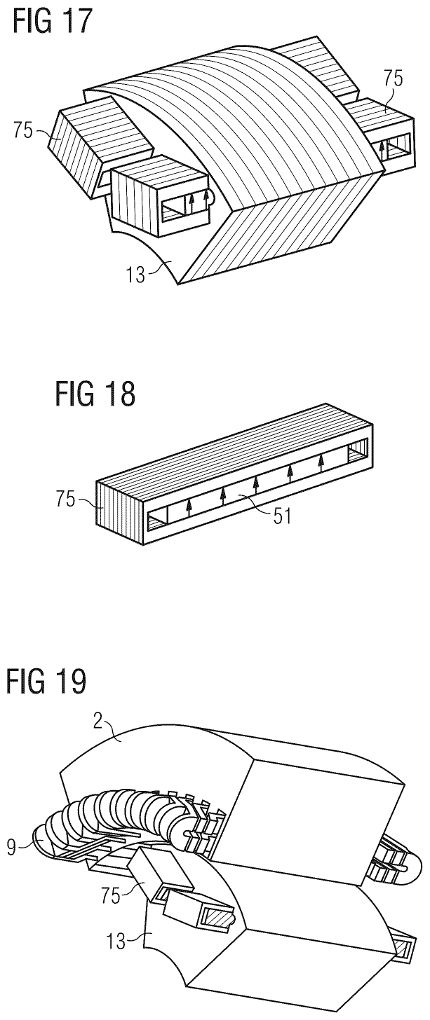

FIGS. 17 and 18 show a further exemplary embodiment, which largely corresponds to that according to FIGS. 14 to 16 and is not described again in this respect.

However, the difference is that both the rotor 13 and the magnet module 75 are not manufactured with SMC or solid iron material, but with laminated iron. It should be emphasized that the direction of lamination of the magnet modules 75 is different from the direction of lamination of the stator 13.

FIG. 18 shows the magnet module 75, which is inserted into the rotor 13 in FIG. 17.

FIG. 19 shows a section of an electric machine with a stator 2 and the rotor 13 as described above. In this case too, it can be seen that the magnet modules 75, which are extended in the axial direction, are arranged below the winding head 9. Here too, there is the effect is that additional magnetic flux is generated, so that the torque and the torque density are higher compared to a conventional machine without extended magnets and without magnet modules.

FIG. 20 shows an exemplary embodiment of an electric machine with the stator 2 and the rotor 14 in a section. This exemplary embodiment largely corresponds to that of FIG. 19, although, in contrast to this, no V-shaped magnets are provided, but instead spoke magnets 52 which each have an associated magnet module 76.

It can be seen that the proposed principle with its advantages can also be applied to spoke magnets in the rotor.

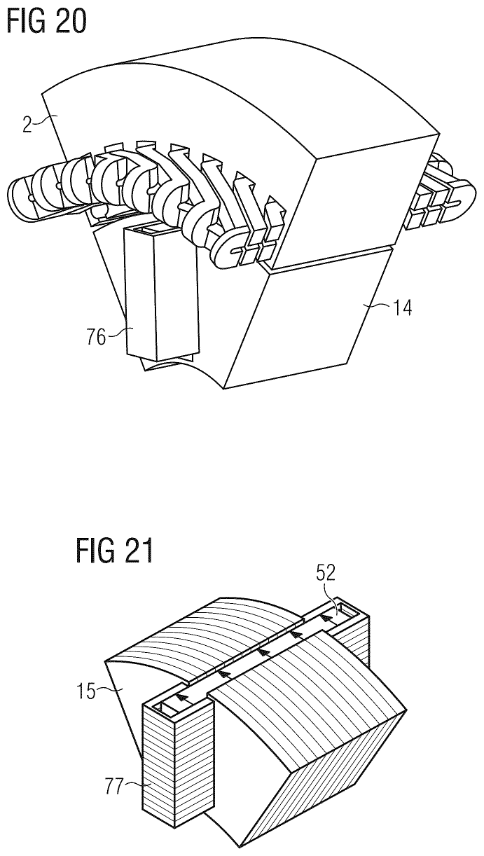

FIG. 21 shows an alternative embodiment of the rotor 14 with respect to FIG. 20, which is designed here as a rotor 15 with laminated iron. The magnet module 77 of the spoke magnet 52 is also made of laminated iron.

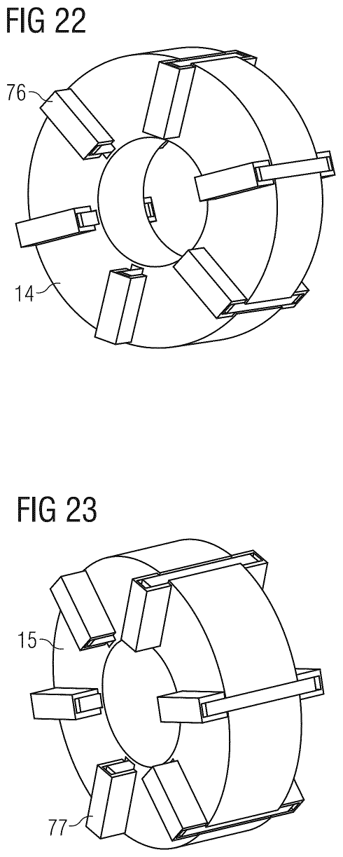

While FIGS. 20 and 21 each show only sections of a rotor 14, 15 with spoke magnets according to the proposed principle, FIGS. 22 and 23 each show an exemplary embodiment of a rotor 14, 15 with six magnet modules 76, 77 each with one spoke magnet.

FIG. 24 shows an exemplary embodiment of a magnet module 7 before the permanent magnet 52 is inserted therein. It can be seen that, as in the example according to FIG. 2, the permanent magnet 52 has a cuboid and flat geometry and fits positively into the magnet module 7, which is also cuboid on the inside and outside. The arrows on the permanent magnet 52 indicate the direction of magnetization with north and south poles. In contrast to the design according to FIG. 2, the permanent magnet comprises several partial magnets made of different materials. In the central area, the permanent magnet 52 comprises a cuboid partial magnet 53 of a first material, for example NdFeB, neodymium-iron-boron. In each axial direction, partial magnets 54 of a second material, in this example ferrite, adjoin the faces of the middle area 53. All areas together form the permanent magnet 52.

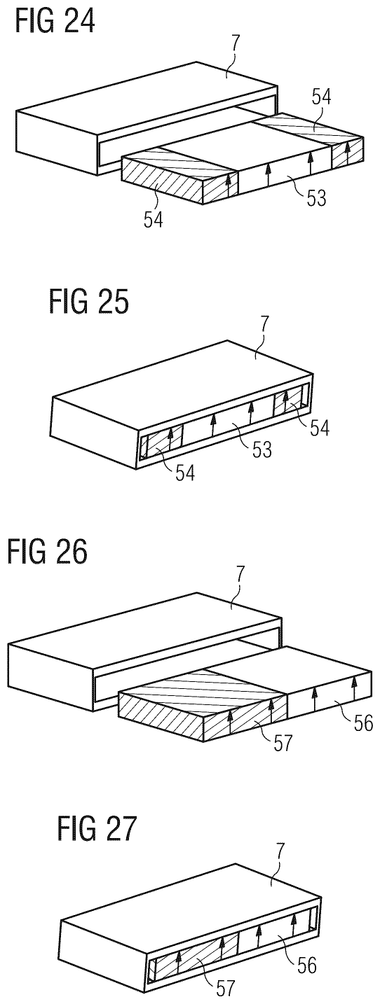

FIG. 25 shows the exemplary embodiment of FIG. 24 after the permanent magnet 52 has been inserted into the magnet module 7.

FIG. 26 shows an exemplary embodiment of a magnet module 7 before the permanent magnet 55 is inserted therein. It can be seen that, as in the example according to FIG. 2, the permanent magnet 55 has a cuboid and flat geometry and fits positively into the magnet module 7, which is also cuboid on the inside and outside. The arrows on the permanent magnet 55 indicate the direction of magnetization with north and south poles. Deviating from the design according to FIG. 2, the permanent magnet comprises several partial magnets that have different materials, with the permanent magnet 55 having two cuboidal parts the faces of which adjoin each other in the axial direction. One half of the permanent magnet 55 comprises a first magnetic material, here NdFeB, and forms a first partial magnet 56, the other half of the permanent magnet comprises a second material, here a ferrite magnet, and forms a second partial magnet 57.

FIG. 27 shows the exemplary embodiment of FIG. 25 after the permanent magnet 55 has been inserted into the magnet module 7.

We claim:

1. A rotor for an electric machine, comprising:
a rotor core and a rotor axle; and
at least one permanent magnet, in which the at least one permanent magnet is extended in axial main direction and has an axial length which is larger than the axial length of the rotor core,
wherein the at least one permanent magnet is arranged in a magnet module in each case, and
wherein the magnet module has a larger axial length than the rotor core.

2. The rotor according to claim 1, wherein the rotor core and/or the magnet module comprise a magnetic material.

3. The rotor according to claim 1, wherein the at least one permanent magnet comprises one of the following types: tangential magnets, V-shaped magnets, spoke magnets.

4. The rotor according to claim 1, wherein the rotor core and/or the magnet module comprise at least one of the following types: a laminated iron core, a soft magnetic composite material, solid steel.

5. The rotor according to claim 1, wherein the magnet module comprises laminated iron, the lamination direction of which is perpendicular to the magnetization direction of the magnet and perpendicular to the lamination direction of the rotor core.

6. The rotor according to claim 1, wherein the permanent magnet comprises several partial magnets made of different material.

7. An electric machine comprising a rotor according to claim 1 and a stator.

8. The electric machine according to claim 7, wherein the stator comprises grooves into which coils of an electric winding are inserted, the stator comprising a winding head on the end face in each case, the axial length of the permanent magnets or the axial length of the magnet modules corresponding to the axial length of the stator with winding heads.
